(19) United States
(12) Patent Application Publication
(10) Pub. No.: US 2022/0101221 A1
(43) Pub. Date: Mar. 31, 2022

(54) ENTERPRISE INFORMATION SECURITY MANAGEMENT SYSTEM

(71) Applicant: Derisk Corp., Waterloo (CA)

(72) Inventor: Jamie HARI, Waterloo (CA)

(73) Assignee: Derisk Corp., Waterloo (CA)

(21) Appl. No.: 17/039,046

(22) Filed: Sep. 30, 2020

(51) Int. Cl. G06Q 10/06; G06Q 30/00; G06Q 50/26; G06Q 10/00; G06Q 10/10; H04L 29/06; G06F 16/28; G06F 16/23

(52) U.S. Cl. CPC G06Q 10/0635; G06Q 30/0185; G06Q 50/26; G06Q 10/20; H04L 63/1425; H04L 63/1416; G06F 16/285; G06F 16/2379; G06Q 10/10

(57) ABSTRACT

A computer-implemented method is disclosed. The method includes: receiving user input of identifying information for an information technology system of a business, the identifying information indicating at least an industry, a type of the business, and one or more computer networks associated with the business; ascertaining, based on the identifying information, at least one regulatory instrument with which the business must comply; scanning the one or more computer networks associated with the business to identify information technology assets of the business; identifying at least one of the information technology assets that are relevant to compliance with the at least one regulatory instrument; conducting a gap analysis based on scanning the at least one of the information technology assets to identify conditions indicative of non-compliance with one or more aspects of the at least one regulatory instrument; identifying, based on the gap analysis, one or more computing tasks that are required to bring the business into compliance with the at least one regulatory instrument; and communicating with a remote ticketing system to generate work tickets corresponding to the one or more computing tasks required to bring the business into compliance with the at least one regulatory instrument.

### TECHNICAL FIELD

The present disclosure relates to computer networks and, in particular, to systems and methods for managing risk and compliance for a business entity in a networked environment.

### BACKGROUND

An information technology (IT) risk and compliance management system oversees an organization's enterprise risk management and compliance with regulations. As different organizations have different risk tolerance and compliance requirements, it is generally challenging for a single platform (or service, software product, etc.) to provide contextual policy, risk, and/or regulatory advice for multitude of business entities.

### BRIEF DESCRIPTION OF DRAWINGS

Reference will now be made, by way of example, to the accompanying drawings which show example embodiments of the present application and in which:

FIG. 1 is a simplified block diagram of an exemplary embodiment of a system for managing information security of an enterprise;

FIG. 2 is high-level schematic diagram of a computing device;

FIG. 3 shows a simplified organization of software components stored in a memory of the computing device of FIG. 2;

FIG. 4 shows, in flowchart form, an example method for automating security threat model generation;

FIG. 5 shows, in flowchart form, an example method for determining a risk-based ranking of information technology assets of a business;

FIG. 6 shows, in flowchart form, an example method for dynamically updating a security threat model for a business;

FIG. 7 shows, in flowchart form, an example method for managing compliance of an information technology system of a business with one or more regulatory instruments; and

FIG. 8 shows, in flowchart form, an example method for tracking a compliance status of a business.

Like reference numerals are used in the drawings to denote like elements and features.

### DETAILED DESCRIPTION OF EXAMPLE EMBODIMENTS

In an aspect, the present disclosure describes a computer-implemented method. The method includes: receiving user input of identifying information for an information technology system of a business, the identifying information indicating at least an industry, a type of the business, and one or more computer networks associated with the business; scanning the one or more computer networks associated with the business to identify information technology assets of the business; assigning at least one of a criticality value or a sensitivity value to one or more of the information technology assets of the business, the assigning of values including: retrieving, from a database storing data relating to pre-categorized information technology assets, criticality values and sensitivity values for those pre-categorized information technology assets in the database that correspond to the one or more information technology assets of the business; and obtaining adjusted criticality values and adjusted sensitivity values for the one or more information technology assets of the business by adjusting the retrieved criticality values and sensitivity values based on the industry and type of the business; and generating, based on the adjusted criticality values and adjusted sensitivity values for the one or more information technology assets of the business, a security threat model for identifying potential security threats to the one or more computer networks of the business.

In some implementations, assigning at least one of the criticality value or the sensitivity value may include assigning both the criticality value and the sensitive value to the one or more of the information technology assets.

In some implementations, assigning at least one of the criticality value or the sensitivity value may include assigning the criticality value and the sensitive value for all of the information technology assets of the business that are identified from the scanning.

In some implementations, the security threat model may comprise a ranking of the one or more information technology assets of the business, wherein a rank of an information technology asset may represent a risk rating associated with the information technology asset in relation to one or more security threats.

In some implementations, the method may further include identifying a set of security threats corresponding to the business, wherein the ranking may be generated based on adjusted criticality and adjusted sensitivity values of the one or more information technology assets of the business and the identified set of security threats.

In some implementations, the method may further include identifying risks to the information technology system of a business based on the security threat model.

In some implementations, identifying risks to the information technology system of the business may include determining a likelihood of security threats to at least one of the information technology assets of the business.

In some implementations, the method may further include determining that the database has been updated based on data associated with information technology assets of at least one other business, and in response to determining that the database has been updated, generating an updated security threat model.

In some implementations, generating the updated security threat model may include obtaining adjusted criticality and adjusted sensitivity values for at least one information technology asset of the business based on the update to the database.

In some implementations, the method may further include: generating recommendations for actions in connection with one or more of the information technology assets of the business based on the security threat model; and outputting the recommendations via a computing device.

In another aspect, the present disclosure describes a computing device. The computing device includes a processor, a communications module coupled to the processor, and a memory coupled to the processor. The memory stores instructions that, when executed, configure the processor to: receive user input of identifying information for an information technology system of a business, the identifying information indicating at least an industry, a type of the business, and one or more computer networks associated with the business; scan the one or more computer networks associated with the business to identify information technology assets of the business; assign at least one of a criticality value or a sensitivity value to one or more of the information technology assets of the business, the assigning of values including: retrieving, from a database storing data relating to pre-categorized information technology assets, criticality values and sensitivity values for those pre-categorized information technology assets in the database that correspond to the one or more information technology assets of the business; and obtaining adjusted criticality values and adjusted sensitivity values for the one or more information technology assets of the business by adjusting the retrieved criticality values and sensitivity values based on the industry and type of the business; and generate, based on the adjusted criticality values and adjusted sensitivity values for the one or more information technology assets of the business, a security threat model for identifying potential security threats to the one or more computer networks of the business.

In another aspect, the present disclosure describes a computer-implemented method. The method includes: receiving user input of identifying information for an information technology system of a business, the identifying information indicating at least an industry, a type of the business, and one or more computer networks associated with the business; ascertaining, based on the identifying information, at least one regulatory instrument with which the business must comply; scanning the one or more computer networks associated with the business to identify information technology assets of the business; identifying at least one of the information technology assets that are relevant to compliance with the at least one regulatory instrument; conducting a gap analysis based on scanning the at least one of the information technology assets to identify conditions indicative of non-compliance with one or more aspects of the at least one regulatory instrument; identifying, based on the gap analysis, one or more computing tasks that are required to bring the business into compliance with the at least one regulatory instrument; and communicating with a remote ticketing system to generate work tickets corresponding to the one or more computing tasks required to bring the business into compliance with the at least one regulatory instrument.

In some implementations, ascertaining the at least one regulatory instrument may include identifying a set of governance documents based on the industry and type of the business, wherein the method may further include processing the set of governance documents to extract textual data indicating technical requirements for compliance with the at least one regulatory instrument.

In some implementations, the set of governance documents may be obtained from one or more remote servers that are accessible to the information technology system of the business.

In some implementations, the method may further include generating a risk management model for identifying risks associated with use of the information technology assets of the business, wherein conducting the gap analysis may include identifying conditions indicative of non-compliance based on the risk management model.

In some implementations, the method may further include: generating recommendations for actions in connection with one or more of the information technology assets of the business based on the risk management model; and outputting the recommendations via a computing device.

In some implementations, the method may further include: monitoring the work tickets corresponding to the one or more computing tasks required to bring the business into compliance with the at least one regulatory instrument; and detecting completion of computing tasks associated with one or more of the work tickets based on the monitoring.

In some implementations, the method may further include determining a compliance status indicating a current level of compliance of the information technology system of the business with a predefined set of one or more regulatory instruments, wherein the compliance status may be updated based on the monitoring of the work tickets.

In some implementations, the compliance status may be indicated as a percentage value.

In some implementations, the method may further include: providing a graphical user interface on a client device associated with the business for presenting query data for one or more queries relating to the information technology assets of the business; and receiving, via the graphical user interface, user input including responses to the one or more queries.

In some implementations, conducting the gap analysis may include identifying conditions indicative of non-compliance with respect to the user inputted responses to the one or more queries.

In another aspect, the present disclosure describes a computing device. The computing device includes a processor, a communications module coupled to the processor, and a memory coupled to the processor. The memory stores instructions that, when executed, configure the processor to: receive user input of identifying information for an information technology system of a business, the identifying information indicating at least an industry, a type of the business, and one or more computer networks associated with the business; ascertain, based on the identifying information, at least one regulatory instrument with which the business must comply; scan the one or more computer networks associated with the business to identify information technology assets of the business; identify at least one of the information technology assets that are relevant to compliance with the at least one regulatory instrument; conduct a gap analysis based on scanning the at least one of the information technology assets to identify conditions indicative of non-compliance with one or more aspects of the at least one regulatory instrument; identify, based on the gap analysis, one or more computing tasks that are required to bring the business into compliance with the at least one regulatory instrument; and communicate with a remote ticketing system to generate work tickets corresponding to the one or more computing tasks required to bring the business into compliance with the at least one regulatory instrument.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term “information technology asset” refers broadly to software or hardware within an information technology environment. Information technology assets may include hardware such as, for example, servers, workstations (e.g. computers, laptops), routers, hubs, switches, data communication lines, network and telecommunications equipment, power systems, storage systems, security systems, mobile devices, infrastructure appliances, Internet-of-Things (IoT) sensors, virtual machines. Additionally, or alternatively, information technology assets may include software including, for example, digital information (e.g. customer or patient records), and intangible assets such as intellectual property and social media accounts.

Example embodiments of the present application are not limited to any particular operating system, system architecture, mobile device architecture, server architecture, or computer programming language.

The present disclosure describes an enterprise risk and compliance management system. More particularly, systems for automated threat modelling and information technology ticket management are disclosed. In accordance with an aspect of the present disclosure, a threat modelling system scans computer networks that are associated with a business to identify information technology assets of the business. The system assigns one or both of a criticality value or a sensitivity value to the identified information technology assets of the business. The values are assigned by retrieving criticality and sensitivity data relating to pre-categorized information technology assets that correspond to the identified information technology assets, and obtaining adjusted criticality values and adjusted sensitivity values by adjusting the retrieved criticality values and sensitivity values based on the industry and type of the business. Based on the adjusted criticality and sensitivity data for the information technology assets of the business, a security threat model is automatically generated for identify potential security threats to the computer network associated with the business.

In accordance with another aspect of the present disclosure, an information technology ticket management system ascertains one or more regulatory instruments with which a business must comply. The system scans the computer networks that are associated with the business to identify information technology assets of the business, and identifies at least one of the information technology assets that are relevant to compliance with the one or more regulatory instruments. The system conducts a gap analysis based on scanning the at least one of the information technology assets to identify conditions indicating that the business is non-compliant with aspects of the one or more regulatory instruments. Based on the gap analysis, the system identifies computing tasks that are required to bring the business into compliance, and communicates with a remote ticketing system to generate work tickets corresponding to the identified computing tasks.

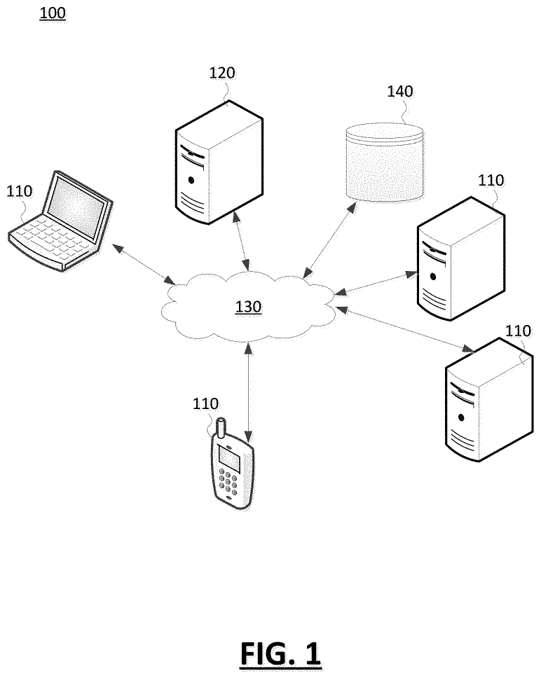

Reference is first made to FIG. 1, which is a schematic diagram illustrating an operating environment of an example embodiment of the present disclosure. FIG. 1 illustrates exemplary components of a system 100 for managing risk and compliance for one or more business entities. As a specific example, the system 100 of FIG. 1 may be implemented to facilitate automated threat modelling and information technology ticket management for a plurality of different business entities.

The system 100 includes a plurality of information technology assets 110, a risk and compliance management server 120, a network 130, and an information technology assets database 140. The risk and compliance management server 120 may serve various functions relating to processing user input data, collection of information technology assets data, querying and updating of one or more database (e.g. the information technology assets database 140), scanning of one or more computer networks, assigning criticality and/or sensitivity values for information technology assets, generation and maintenance of security threat models, obtaining regulatory instruments data, and managing a ticketing system for generating and monitoring work tickets corresponding to various computing tasks.

The information technology assets database 140 stores a wide range of asset data in connection with a plurality of information technology assets of one or more enterprises (or business entities). In particular, the information technology assets database 140 may store criticality values (which reflect criticality of an asset to the associated enterprise) and/or sensitivity values (which reflect sensitivity of data associated with the asset) for each of one or more of the information technology assets that are included in the inventory of assets for the enterprises.

The information technology assets 110, the risk and compliance management server 120, and the information technology assets database 140 may be in geographically disparate locations. Put differently, each of the information technology assets 110, the risk and compliance management server 120, and the information technology assets database 140 may be remote from others of the information technology assets 110, the risk and compliance management server 120, and the information technology assets database 140.

The information technology assets 110, the risk and compliance management server 120, and the information technology assets database 140 may each be a computer system and/or a computing device.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, or the like. Additionally, or alternatively, the network 130 may be or may include one or more payment networks. The network 130 may, in some embodiments, include a plurality of distinct networks. For example, communications between certain of the computer systems may be over a private network whereas communications between other of the computer systems may be over a public network, such as the Internet.

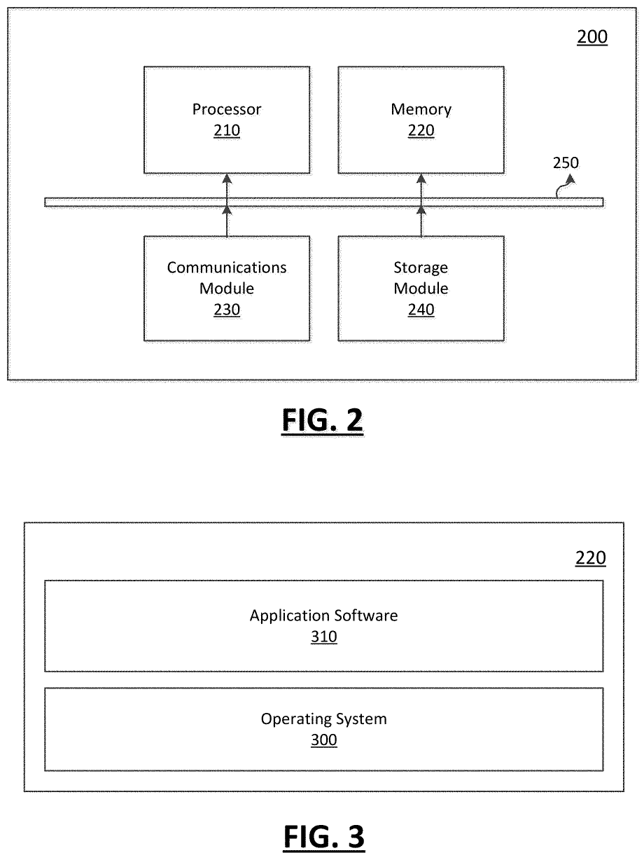

Referring now to FIG. 2, a high-level operation diagram of an example computing device 200 will now be described. The example computing device 200 may be exemplary of one or more of the information technology assets 110, the risk and compliance management server 120, and the information technology assets database 140.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel ×86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The computing device 200 will include other components apart from those illustrated in FIG. 2 and the specific component set may differ based on whether the computing device 200 is operating as the information technology assets 110, the risk and compliance management server 120, and the information technology assets database 140. For example, the computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the computing devices 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

FIG. 3 depicts a simplified organization of software components stored in the memory 220 of the example computing device 200 (FIG. 2). As illustrated, these software components include an operating system 300 and an application software 310.

The operating system 300 is software. The operating system 300 allows the application software 310 to access the processor 210 (FIG. 2), the memory 220, and the communications module 230 of the example computing device 200 (FIG. 2). The operating system 300 may be, for example, Google™ Android™, Apple™ iOS™, UNIX™, Linux™, Microsoft™ Windows™ Apple OSX™ or the like.

The application software 310 adapts the example computing device 200, in combination with the operating system 300, to operate as a device performing a particular function. For example, the application software 310 may cooperate with the operating system 300 to adapt a suitable embodiment of the example computing device 200 to operate as the information technology assets 110, the risk and compliance management server 120, or the information technology assets database 140.

While a single application software 310 is illustrated in FIG. 3, in operation the memory 220 may include more than one application software 310 and different application software 310 may perform different operations.

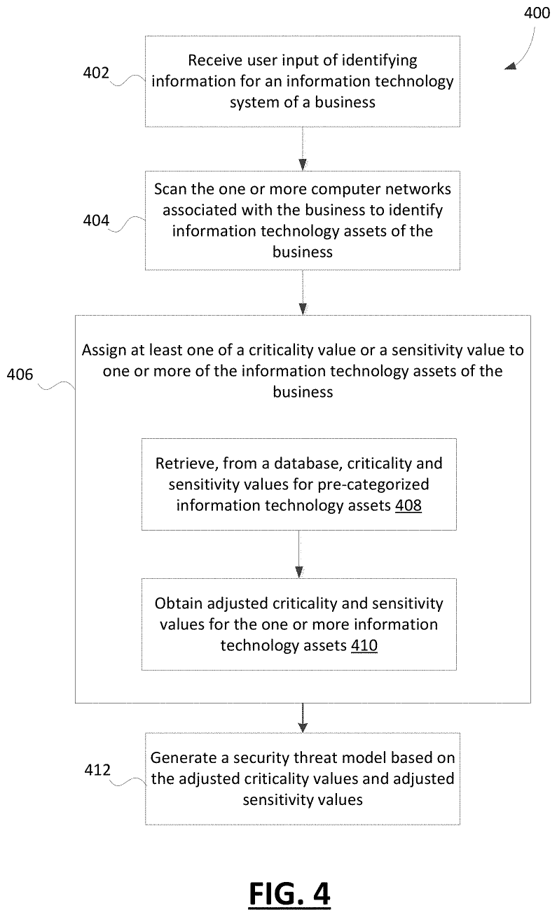

Reference is now made to FIG. 4, which shows, in flowchart form, an example method 400 for automating the generation of a security threat model for a business entity. Operations starting with operation 402 and continuing onward are performed by the processor 210 (FIG. 2) of a computing device 200 executing software comprising instructions such as may be stored in the memory 220 of the computing device 200. Specifically, the operations of the method 400 may be performed by a risk and compliance management system. For example, processor-executable instructions may, when executed, configure a processor 210 of the risk and compliance management server 120 to perform the method 400.

In operation 402, the system receives user input of identifying information for an information technology system of a business. The identifying information indicates, at least, an industry, a type of the business, and one or more computer networks associated with the business.

In operation 404, the system scans the one or more computer networks associated with the business to identify information technology assets of the business. The computer networks may include one or more private intranets that spans multiple computing devices (e.g. a company-wide intranet), one or more extranets which may be accessed by customers, supplies, or other approved parties, or other publicly available networks. The system may store data relating to the identified information technology assets in a database, such as the information technology assets database 140 of FIG. 1.

In operation 406, the system assigns at least one of a criticality value or a sensitivity value to one or more of the information technology assets of the business. In some embodiments, both the system may assign both a criticality value and a sensitivity value to the one or more information technology assets. The criticality values and sensitivity values may be assigned to all of the information technology assets of the business that are identified from the scanning, or a subset of all information technology assets. The criticality values and sensitivity values may, in some embodiments, be expressed as numerical values, a rating, or a rank (in a ranking). In assigning the criticality and/or sensitivity values, the system may be configured to perform operations 408 and 410 as described below.

In operation 408, the system retrieves, from a database storing data relating to pre-categorized information technology assets, criticality values and sensitivity values for those pre-categorized information technology assets in the database that correspond to the one or more information technology assets of the business. The database may, for example, store asset data for information technology assets that are associated with one or more entities other than the business. The system may determine mappings of the business' information technology assets to the pre-categorized information technology assets and, based on the mappings, retrieve (via database queries, for example) criticality and/or sensitivity values for the information technology assets of the business.

In operation 410, the system obtains adjusted criticality values and adjusted sensitivity values for the one or more information technology assets of the business. The adjusted values are obtained by adjusting the retrieved criticality values and sensitivity values based on the industry and type of the business. The adjustments are intended to account for the specific industry and business type associated with the business. For example, the retrieved values of criticality and/or sensitivity for the information technology assets of the business may be increased or decrease to yield adjusted criticality and/or sensitivity values, where the increase/decrease is dependent on the industry and type of the business.

In operation 412, the system automatically generates a security threat model for identifying potential security threats to the one or more computer networks of the business, based on the adjusted criticality values and adjusted sensitivity values for the one or more information technology assets of the business. The security threat model may, for example, include a mapping of information technology assets of the business to their corresponding values of criticality and/or sensitivity. The security threat model may, in some embodiments, identify one or more security threats that are relevant for the information technology assets of the business. In at least some embodiments, the security threat model is used for identifying risks to the information technology system of the business. In particular, identifying risks may include determining a likelihood of security threats to one or more of the information technology assets of the business based on the security threat model.

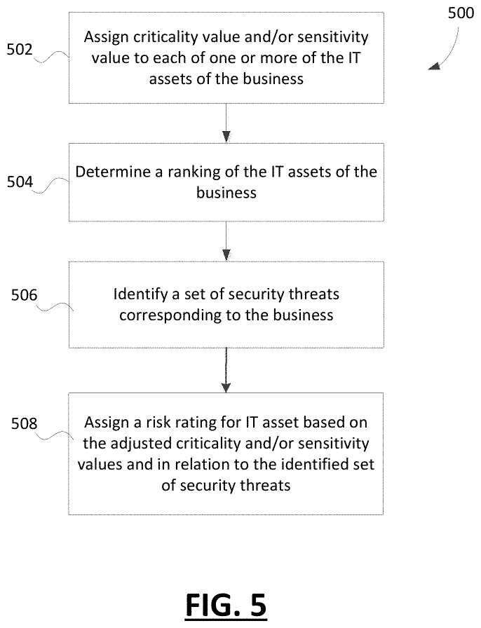

Reference is now made to FIG. 5, which shows, in flowchart form, an example method 500 for determining a risk-based ranking of information technology assets of a business entity. Operations starting with operation 502 and continuing onward are performed by the processor 210 (FIG. 2) of a computing device 200 executing software comprising instructions such as may be stored in the memory 220 of the computing device 200. Specifically, the operations of the method 500 may be performed by a risk and compliance management system. For example, processor-executable instructions may, when executed, configure a processor 210 of the risk and compliance management server 120 to perform the method 500. The operations of method 500 may be performed in addition to, or as alternatives of, one or more of the operations of method 400 of FIG. 4. For example, in some embodiments, all or parts of method 500 may be performed as subprocesses of method 400.

In operation 502, the system assigns criticality values and/or sensitivity values to each of one or more of the information technology assets of the business. The criticality and/or sensitivity values may be assigned in accordance with the techniques described with reference to method 400. For example, the system may be configured to determine adjusted criticality and/or sensitivity values for the one or more information technology assets of the business. In operation 504, the system determines a ranking of the information technology assets. More generally, a ranking of the information technology assets may be generated as part of a security threat model for the business. This ranking may provide an indication of which information technology assets to prioritize when managing risk of security threats. That is, the ranking may identify potential security issues and associated priority (or importance, urgency, etc.) of such security issues.

In some embodiments, the ranking of the information technology assets may be generated based on the adjusted criticality and/or sensitivity values associated with the information technology assets of the business. The ranking may, for example, be determined based on predefined criteria relating to criticality and sensitivity of information technology assets. For example, higher rank may be assigned to information technology assets that have high criticality and/or high sensitivity values (or high cumulative values).

In operation 506, the system identifies a set of security threats corresponding to the business. For example, the system may retrieve, from a database storing information relating to known information system security threats, a data set containing data associated with security threats that are relevant for the system. In operation 508, the system assigns a risk rating for information technology assets based on the adjusted criticality and/or adjusted sensitivity values and in relation to the identified set of security threats. In at least some embodiments, the rank of an information technology asset may represent a risk rating associated with said asset in relation to the one or more identified security threats. For example, a high rating, and accordingly a high rank, may signal that a particular information technology asset may be at an increased risk of exposure to security threat(s), or that a risk of a security threat for that asset is of high priority for the information technology system of the business. In some embodiments, the security threat model may include a ranking of the identified security threats based on predetermined order criteria. The ranking of the identified security threats and the ranking of the information technology assets may, for example, be combined into a consolidated ranking.

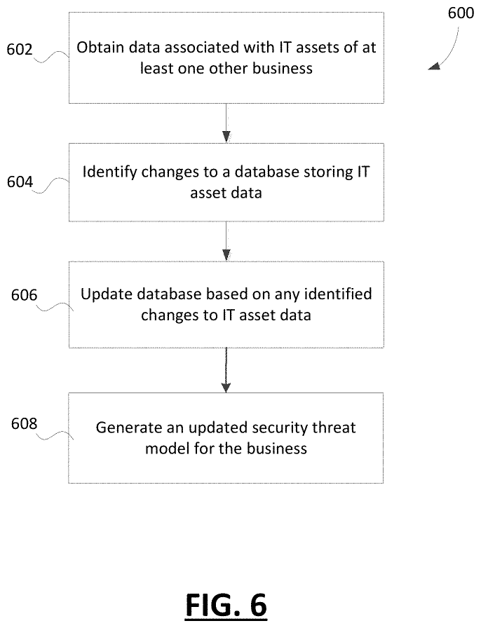

Reference is now made to FIG. 6, which shows, in flowchart form, an example method 600 for dynamically updating a security threat model of a business entity. Operations starting with operation 602 and continuing onward are performed by the processor 210 (FIG. 2) of a computing device 200 executing software comprising instructions such as may be stored in the memory 220 of the computing device 200. Specifically, the operations of the method 600 may be performed by a risk and compliance management system. For example, processor-executable instructions may, when executed, configure a processor 210 of the risk and compliance management server 120 to perform the method 600. The operations of method 600 may be performed in addition to, or as alternatives of, one or more of the operations of method 400 of FIG. 4 and method 500 of FIG. 5. Specifically, in some embodiments, all or parts of method 600 may be performed as subprocesses of one or both of methods 400 and 500.

In operation 602, the system obtains data associated with information technology assets of at least one business other than a first business. More particularly, the system obtains asset data for information technology assets that are owned, operated, and/or managed by one or more other businesses. In this way, the system may crowd-source information technology asset data from a plurality of different sources (e.g. enterprises), and use the crowd-sourced asset data for security threat modelling and risk strategizing.

In operation 604, the system identifies changes to the database storing the information technology asset data. The database may store data relating to information technology assets associated with a plurality of enterprises, as well as relevant security threats for the information technology assets of the database. In some embodiments, the system may determine whether a criticality value and/or a sensitivity value associated with one or more of the information technology assets included in the database has changed (i.e. increased or decreased). Additionally, or alternatively, the system may determine whether there are any changes to security threats data (e.g. new security threats, updated risk level associated with known threats, etc.), and update the database based on any changes to the security threats data. The system updates the database based on the identified changes to the information technology asset data, in operation 606.

In operation 608, the system generates an updated security threat model for the business. More specifically, in response to determining that the database has been updated based on data associated with information technology assets of at least one other business, the system generates an updated security threat model for the first business. When generating the updated security threat model, the system may obtain adjusted criticality and adjusted sensitivity values for at least one information technology asset of the first business based on the update to the database.

In at least some embodiments, the system may provide recommendations relating to security risk and threat management directly to computing devices associated with the business entity. In particular, the system may generate recommendations for actions in connection with one or more of the information technology assets of the business based on the security threat model. The system may output these recommendations via a computing device associated with the business entity, for example, by transmitting the recommendations data to the computing device for display thereon.

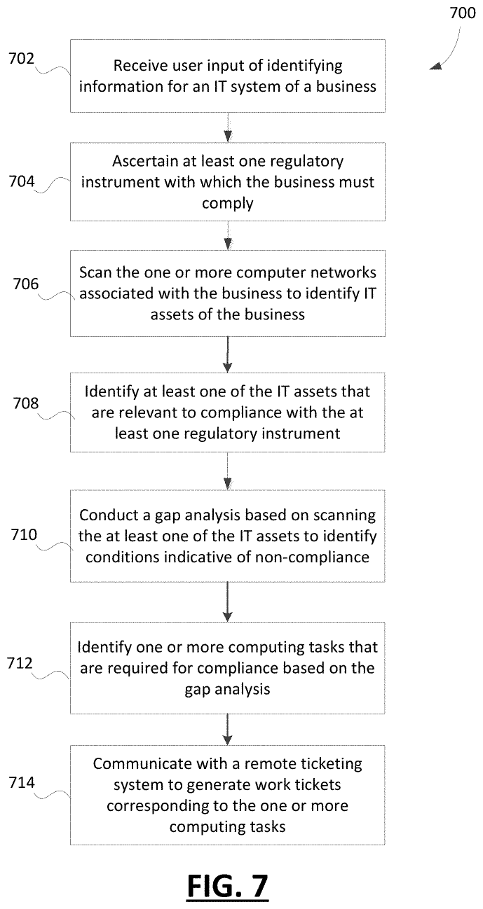

Reference is now made to FIG. 7, which shows, in flowchart form, an example method 700 for managing compliance of an information technology system of a business with one or more regulatory instruments. Operations starting with operation 702 and continuing onward are performed by the processor 210 (FIG. 2) of a computing device 200 executing software comprising instructions such as may be stored in the memory 220 of the computing device 200. Specifically, the operations of the method 700 may be performed by a risk and compliance management system. For example, processor-executable instructions may, when executed, configure a processor 210 of the risk and compliance management server 120 to perform the method 700.

In operation 702, the system receives user input of identifying information for an information technology system of a business. The identifying information indicates, at least, an industry, a type of the business, and one or more computer networks associated with the business.

In operation 704, the system ascertains, based on the identifying information, at least one regulatory instrument with which the business must comply. In at least some embodiments, the system may identify a set of governance documents based on the industry and type of the business, and process the documents to extract data indicating technical requirements for compliance with the at least one regulatory instrument. The set of governance documents may, for example, be obtained from one or more remote servers that are accessible to the information technology system of the business.

In operation 706, the system scans the one or more computer networks associated with the business to identify information technology assets of the business. The one or more computer networks may include, for example, private intranets, extranets, or other publicly accessible networks.

In operation 708, the system identifies at least one of the information technology assets that are relevant to compliance with the at least one regulatory instrument. For example, based on data extracted from the at least one regulatory instrument, the system may identify one or more information technology assets whose properties (e.g. usage, acquisition, etc.) are required to comply with defined rules within the at least one regulatory instrument. In some embodiments, the system may determine mappings between the information technology assets and rules (or policies, etc.) contained in the at least one regulatory instrument. Such mappings may usefully be employed in identifying the relevant information technology assets in operation 708.

In operation 710, the system conducts a gap analysis based on scanning the at least one of the information technology assets to identify conditions indicative of non-compliance with one or more aspects of the at least one regulatory instrument. The conditions of non-compliance represent properties of one or more information technology assets that do not satisfy compliance criteria associated with the one or more aspects of the at least one regulatory instrument. The system may scan the information technology assets and determine whether any such asset fails to satisfy any one or all of the compliance criteria associated with the at least one regulatory instrument. For example, the system may identify hardware owned by the business entity which is running an outdated version of an operating software. The outdated operating software may fail to satisfy security requirements of one or more regulatory instruments (e.g. financial services cybersecurity regulations, general data protection regulations, etc.) due to potential security vulnerabilities that have not been patched by updates to the operating software. The system performs such comparison of properties of information technology assets to rules and policies of the at least one regulatory instrument.

In some embodiments, the system may generate a risk management model for identifying risks associated with use of the information technology assets of the business. The system may then conduct the gap analysis by identifying conditions indicative of non-compliance based on the generated risk management model. Additionally, or alternatively, the system may generate recommendations for actions in connection with one or more of the information technology assets of the business based on the risk management model, and output the recommendations via a computing device associated with the business entity. For example, the system may transmit recommendations data to a computing device associated with the business for display thereon.

In some embodiments, the system may be configured to provide a graphical user interface on a computing device associated with the business for presenting query data for one or more queries relating to the information technology assets of the business. The system may then receive, via the graphical user interface, user input including responses to the one or more queries. The system may then conduct the gap analysis by identifying conditions indicative of non-compliance with respect to the user inputted responses to the one or more queries.

In operation 712, the system identifies, based on the gap analysis, one or more computing tasks that are required to bring the business into compliance with the at least one regulatory instrument. In operation 714, the system communicates with a remote ticketing system to generate work tickets corresponding to the one or more computing tasks that are required to bring the business into compliance with the at least one regulatory instrument.

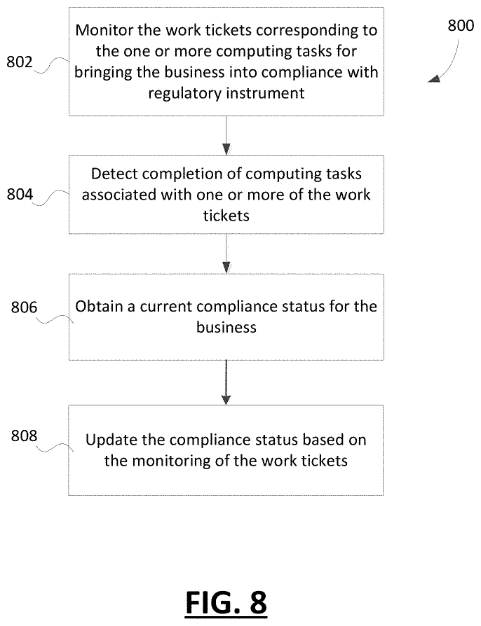

Reference is now made to FIG. 8, which shows, in flowchart form, an example method 800 for tracking a compliance status of a business entity with respect to one or more regulatory instruments. Operations starting with operation 802 and continuing onward are performed by the processor 210 (FIG. 2) of a computing device 200 executing software comprising instructions such as may be stored in the memory 220 of the computing device 200. Specifically, the operations of the method 800 may be performed by a risk and compliance management system. For example, processor-executable instructions may, when executed, configure a processor 210 of the risk and compliance management server 120 to perform the method 800. The operations of method 800 may be performed in addition to, or as alternatives of, one or more of the operations of method 700 of FIG. 7. Specifically, in some embodiments, all or parts of method 800 may be performed as subprocesses of method 700.

In operation 802, the system monitors the work tickets corresponding to the one or more computing tasks required to bring the business into compliance with at least one regulatory instrument. For example, the system may communicate with a ticketing system that generates and manages the work tickets to receive updates (e.g. periodic updates) relating to the completion status of the one or more computing tasks.

In operation 804, the system detects completion of computing tasks associated with one or more of the work tickets based on the monitoring. In operation 806, the system obtains a current compliance status for the business. A compliance status indicates a current level of compliance of the information technology system of the business with a predefined set of one or more regulatory instruments. In some embodiments, the compliance status may be indicated as a percentage value, representing progress of the business toward compliance with all regulatory requirements (or at least a defined set of regulatory requirements) relevant for the business.

In operation 808, the system updates the compliance status of the business based on the monitoring of the work tickets. For example, a percentage value reflecting the compliance status of the business may be increased according to weights associated with the completed computing tasks. The compliance status may be transmitted to computing devices associated with the business entity, for example, for display thereon.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method, comprising:
receiving user input of identifying information for an information technology system of a business, the identifying information indicating at least an industry, a type of the business, and one or more computer networks associated with the business;
scanning the one or more computer networks associated with the business to identify information technology assets of the business;
assigning at least one of a criticality value or a sensitivity value to one or more of the information technology assets of the business, the assigning of values including:
retrieving, from a database storing data relating to pre-categorized information technology assets, criticality values and sensitivity values for those pre-categorized information technology assets in the database that correspond to the one or more information technology assets of the business; and
obtaining adjusted criticality values and adjusted sensitivity values for the one or more information technology assets of the business by adjusting the retrieved criticality values and sensitivity values based on the industry and type of the business; and
generating, based on the adjusted criticality values and adjusted sensitivity values for the one or more information technology assets of the business, a security threat model for identifying potential security threats to the one or more computer networks of the business.

2. The method of claim 1, wherein assigning at least one of the criticality value or the sensitivity value comprises assigning both the criticality value and the sensitive value to the one or more of the information technology assets.

3. The method of claim 2, wherein assigning at least one of the criticality value or the sensitivity value comprises assigning the criticality value and the sensitive value for all of the information technology assets of the business that are identified from the scanning.

4. The method of claim 1, wherein the security threat model comprises a ranking of the one or more information technology assets of the business and wherein a rank of an information technology asset represents a risk rating associated with the information technology asset in relation to one or more security threats.

5. The method of claim 4, further comprising identifying a set of security threats corresponding to the business, wherein the ranking is generated based on adjusted criticality and adjusted sensitivity values of the one or more information technology assets of the business and the identified set of security threats.

6. The method of claim 1, further comprising identifying risks to the information technology system of a business based on the security threat model.

7. The method of claim 6, wherein identifying risks to the information technology system of the business comprises determining a likelihood of security threats to at least one of the information technology assets of the business.

8. The method of claim 1, further comprising:
determining that the database has been updated based on data associated with information technology assets of at least one other business;
in response to determining that the database has been updated, generating an updated security threat model.

9. The method of claim 8, wherein generating the updated security threat model comprises obtaining adjusted criticality and adjusted sensitivity values for at least one information technology asset of the business based on the update to the database.

10. The method of claim 1, further comprising:
generating recommendations for actions in connection with one or more of the information technology assets of the business based on the security threat model; and
outputting the recommendations via a computing device.

11. A computer-implemented method comprising:
receiving user input of identifying information for an information technology system of a business, the identifying information indicating at least an industry, a type of the business, and one or more computer networks associated with the business;
ascertaining, based on the identifying information, at least one regulatory instrument with which the business must comply;
scanning the one or more computer networks associated with the business to identify information technology assets of the business;
identifying at least one of the information technology assets that are relevant to compliance with the at least one regulatory instrument;
conducting a gap analysis based on scanning the at least one of the information technology assets to identify conditions indicative of non-compliance with one or more aspects of the at least one regulatory instrument;
identifying, based on the gap analysis, one or more computing tasks that are required to bring the business into compliance with the at least one regulatory instrument; and
communicating with a remote ticketing system to generate work tickets corresponding to the one or more computing tasks required to bring the business into compliance with the at least one regulatory instrument.

12. The method of claim 11, wherein ascertaining the at least one regulatory instrument comprises identifying a set of governance documents based on the industry and type of the business, and wherein the method further comprises processing the set of governance documents to extract textual data indicating technical requirements for compliance with the at least one regulatory instrument.

13. The method of claim 12, wherein the set of governance documents are obtained from one or more remote servers that are accessible to the information technology system of the business.

14. The method of claim 11, further comprising generating a risk management model for identifying risks associated with use of the information technology assets of the business, wherein conducting the gap analysis comprises identifying conditions indicative of non-compliance based on the risk management model.

15. The method of claim 14, further comprising:
generating recommendations for actions in connection with one or more of the information technology assets of the business based on the risk management model; and
outputting the recommendations via a computing device.

16. The method of claim 11, further comprising:
monitoring the work tickets corresponding to the one or more computing tasks required to bring the business into compliance with the at least one regulatory instrument; and
detecting completion of computing tasks associated with one or more of the work tickets based on the monitoring.

17. The method of claim 16, further comprising determining a compliance status indicating a current level of compliance of the information technology system of the business with a predefined set of one or more regulatory instruments, wherein the compliance status is updated based on the monitoring of the work tickets.

18. The method of claim 17, wherein the compliance status is indicated as a percentage value.

19. The method of claim 11, further comprising:
providing a graphical user interface on a client device associated with the business for presenting query data for one or more queries relating to the information technology assets of the business; and
receiving, via the graphical user interface, user input including responses to the one or more queries.

20. The method of claim 19, wherein conducting the gap analysis comprises identifying conditions indicative of non-compliance with respect to the user inputted responses to the one or more queries.
